(19) United States
(12) Patent Application Publication
(10) Pub. No.: US 2024/0184954 A1
(43) Pub. Date: Jun. 6, 2024

(54) ITERATIVE MODEL COMPENSATION

(71) Applicant: Hewlett-Packard Development Company, L.P., Spring, TX (US)

(72) Inventors: Carlos Alberto LOPEZ COLLIER DE LA MARLIERE, Guadalajara JAL (MX); Jorge Alberto BECERRA VELAZQUEZ, Guadalajara JAL (MX); Lei CHEN, Shanghai (CN); Jun ZENG, Palo Alto, CA (US)

(73) Assignee: Hewlett-Packard Development Company, L.P., Spring, TX (US)

(21) Appl. No.: 18/285,680

(22) PCT Filed: Apr. 21, 2021
(86) PCT No.: PCT/US2021/028003

§ 371 Date: Oct. 5, 2023

(51) Int. Cl. G06F 30/23; G06F 113/10

(52) U.S. Cl. CPC G06F 30/23; G06F 2113/10

(57) ABSTRACT

Examples of methods for iterative model compensation are described herein. In some examples, a method includes predicting, in an iteration, a deformed model based on an object model. In some examples, the method includes determining, in the iteration, a disparity between the object model and the deformed model. In some examples, the method includes determining, in a next iteration, a compensated model based on the disparity and a relaxation factor.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for iterative model compensation;

FIG. 2 is a flow diagram illustrating another example of a method for iterative model compensation;

FIG. 3 is a block diagram of an example of an apparatus that may be used in iterative model compensation;

FIG. 4 is a block diagram illustrating an example of a computer-readable medium for iterative model compensation;

FIG. 5 is a diagram illustrating an example of deformed model prediction and an example of compensated model determination in accordance with some examples of the techniques described herein; and

FIG. 6 is a diagram illustrating an example of iterative model compensation in accordance with some examples of the techniques described herein.

### DETAILED DESCRIPTION

Additive manufacturing may be used to manufacture three-dimensional (3D) objects. 3D printing is an example of additive manufacturing. Metal printing (e.g., metal binding printing, Metal Jet Fusion, etc.) is an example of 3D printing. In some examples, metal powder may be glued at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size.

Some examples of the techniques described herein may be utilized for various examples of additive manufacturing. For instance, some examples may be utilized for metal printing. Some metal printing techniques may be powder-based and driven by powder gluing and/or sintering. Some examples of the approaches described herein may be applied to area-based powder bed metal printing, such as binder jet, Metal Jet Fusion, and/or metal binding printing, etc. Some examples of the approaches described herein may be applied to additive manufacturing where an agent or agents (e.g., latex) carried by droplets are utilized for voxel-level powder binding.

In some examples, metal printing may include multiple stages. In a first stage, the printer (e.g., print head, carriage, agent dispenser, and/or nozzle, etc.) may apply an agent or agents (e.g., binding agent, glue, latex, etc.) to loose metal powder layer-by-layer to produce a glued precursor (or “green”) object. A precursor object is a mass of metal powder and adhesive. A second stage may include curation. A third stage may include de-caking. In a fourth stage, a precursor part may be sintered (e.g., heated) to produce an end object. For example, the glued precursor object may be placed in a furnace to be sintered to produce the end object. Sintering may cause the metal powder to melt and fuse, and/or may cause the agent to be burned off. An end object is an object formed from a manufacturing procedure or procedures. In some examples, an end object may undergo a further manufacturing procedure or procedures (e.g., support removal, polishing, assembly, painting, finishing, etc.). A precursor object may have an approximate shape of an end object.

Some examples of metal printing may present challenges in controlling the shape (e.g., geometry) of the end object. For example, the application (e.g., injection) of agent(s) (e.g., glue, latex, etc.) may lead to porosity in the precursor part, which may significantly influence the shape of the end object. In some examples, metal powder fusion (e.g., fusion of metal particles) may be separated from the layer-by-layer printing procedure, which may limit control over sintering and/or fusion.

In some examples, metal sintering may be performed in approaches for metal injection molded (MIM) objects and/or binder jet. In some cases, metal sintering may introduce a deformation and/or change in an object varying from 25% to 50% depending on precursor object porosity.

End object geometrical accuracy is a challenge in some approaches to additive manufacturing. The challenge may be due to porous precursor objects that may experience approximately 50% in volumetric shrinkage with sintering and/or due to non-isotropic shrinkage from non-uniform stress built-up during sintering. Examples of deformations may include gravitational sag (e.g., feature location disruption due to insufficient support), gravitational slump (e.g., downward flow of material changing part thickness), and/or surface drag (e.g., distortion caused by friction between an object and a supporting surface during movement induced by object shrinkage).

Some examples of the techniques described herein may address the foregoing issues by automatically generating precursor object geometry that may result in a sintered object that meets a design tolerance or tolerances. For instance, some of the techniques described herein may help to compensate for deformation due to sintering by creating geometry for the precursor object. Increasing manufacturing accuracy may help to reduce manufacturing trial-and-error and/or may help to increase yield.

Some examples of the techniques described herein may include an iterative generator-predictor architecture that drives converging towards a precursor object geometry that may produce a sintered object that meets design tolerance(s). Some examples of the architecture may be flexible to account for deformation non-linearity(ies), sintering procedure complexity, sintering thermal profile complexity, and/or diverse precursor object qualities (e.g., porosity). In some examples, generation techniques may include voxel-level quality(ies) including displacement and/or porosity generated by prediction techniques to allow faster convergence towards more accurate precursor object geometry accounting for sintering physics. Some examples of the techniques described herein may be utilized for different precursor object production techniques, e.g., different binding agents (e.g., glues), different powder spread techniques, MIM, MetJet, and/or binder jet, etc.

Some examples of the techniques described herein may be performed in an offline loop. An offline loop is a procedure that is performed independent of (e.g., before) manufacturing, without manufacturing the object, and/or without measuring (e.g., scanning) the manufactured object. In some examples, an iteration or iterations described herein may not include manufacturing an object and/or may not include measuring a manufactured object.

Throughout the drawings, identical reference numbers may or may not designate similar or identical elements. Similar numbers may or may not indicate similar elements. When an element is referred to without a reference number, this may refer to the element generally, with or without limitation to any particular drawing or figure. The drawings are not necessarily to scale, and the size of some parts may be exaggerated to more clearly illustrate the example shown. Moreover, the drawings provide examples in accordance with the description. However, the description is not limited to the examples provided in the drawings.

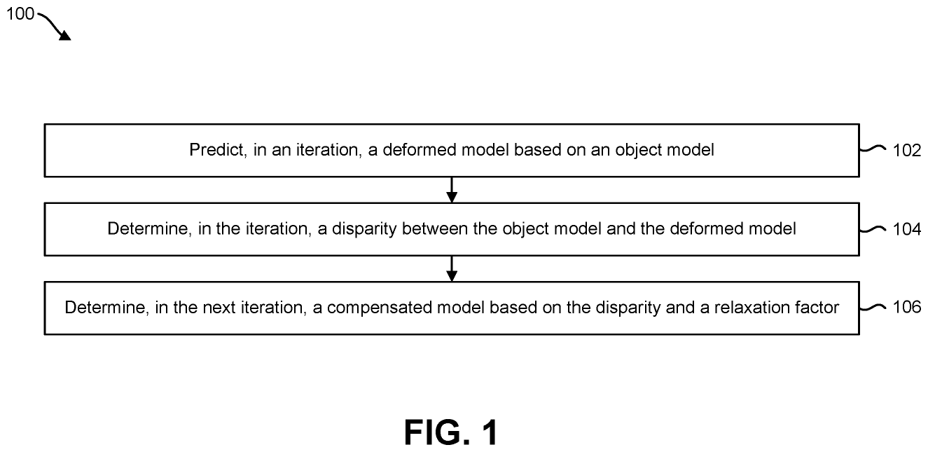

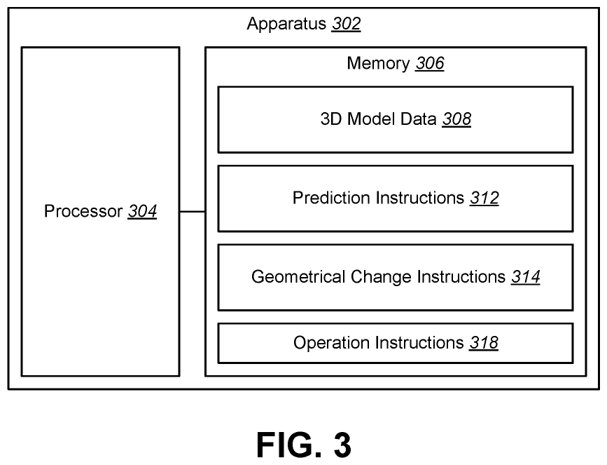

FIG. 1 is a flow diagram illustrating an example of a method 100 for iterative model compensation. The method 100 and/or an element or elements of the method 100 may be performed by an apparatus (e.g., electronic device). For example, the method 100 may be performed by the apparatus 302 described in connection with FIG. 3.

The apparatus may predict 102, in an iteration, a deformed model based on an object model. In some examples, the deformed model may be predicted based on an object model in a voxel space. A voxel space may be a plurality of voxels. In some examples, a voxel space may represent a build volume and/or a sintering volume. A build volume is a 3D space for object manufacturing. For example, a build volume may be a cuboid space in which an apparatus (e.g., computer, 3D printer, etc.) may deposit material (e.g., metal powder, metal particles, etc.) and agent(s) (e.g., glue, latex, etc.) to manufacture an object (e.g., precursor object). In some examples, an apparatus may progressively fill a build volume layer-by-layer with material and agent during manufacturing. A sintering volume is a 3D space for object sintering (e.g., oven). For instance, a precursor object may be placed in a sintering volume for sintering. In some examples, a voxel space may be expressed in coordinates. For example, locations in a voxel space may be expressed in three coordinates: X (e.g., width), Y (e.g., length), and Z (e.g., height).

An object model is a geometrical model of an object. For instance, an object model may be a three-dimensional (3D) model representing an object. Examples of object models include computer-aided design (CAD) models, mesh models, 3D surfaces, etc. An object model may be expressed as a set of points, surfaces, faces, vertices, etc. In some examples, the apparatus may receive an object model from another device (e.g., linked device, networked device, removable storage, etc.) or may generate the 3D object model. Some examples of an object model may include a target object model, a compensated model, and/or a proposed model. A target object model is an object model that represents a target geometry (e.g., target dimension(s), size, and/or shape) of an object. In some examples, a target object model may be an original object model without compensation. A compensated model is an object model with compensation (e.g., adjustment(s), geometrical change, modification, etc.). For instance, a compensated model may be an object model with compensation for a deformation or deformations (e.g., anticipated, predicted, simulated, etc., deformation(s)). A proposed model is an object model proposed to address deformation. For instance, a proposed model may be an object model computed to compensate for a deformation or deformations.

An iteration is an instance of a repetitive procedure or loop. For example, an iteration may include a sequence of operations that may iterate and/or recur. For instance, an iteration may be a series of executed instructions in a loop.

A deformed model is a model resulting from a deformation. For instance, a deformation may be an alteration of a model due to a force(s) and/or energy(ies) applied to a model. For example, force(s) and/or energy(ies) (e.g., gravity, heat, pressure, sintering, etc.) may be applied to (e.g., simulated on) an object model to produce a deformed model.

In some examples, predicting 102 the deformed model may include performing a simulation. Examples of simulation approaches that may be utilized to predict the deformed model may include finite element analysis (FEA) and/or machine learning approaches. For instance, predicting 102 the deformed model may utilize the geometry of the object model (e.g., target object model, precursor object model, compensated model, proposed model, etc.) to simulate sintering of the object model. Predicting 102 the deformed model may include predicting the sintering of the object model to produce the deformed model and/or other associated data (e.g., associated voxel data, displacement field(s), temperature(s), etc.).

In some examples for an initial iteration, the object model may be a target object model and/or original object model (e.g., original precursor object model geometry, initial object model, etc.). The target object model and/or original object model may be denoted X₀. For instance, X₀ may refer to an original mesh and/or a target mesh after sintering. Predicting 102 the deformed model may be performed based on X₀ to produce the deformed model. In some examples, the deformed model may be denoted X_{f}. For instance, X_{f} may indicate the deformed model of the current iteration.

In some examples, predicting 102 the deformed model may include predicting a displacement field. The displacement field may be denoted U. A displacement field is data that indicates a deformation or deformations. For instance, a displacement field may indicate deformation resulting from sintering (e.g., simulated sintering). In some examples, the displacement field may be expressed as spatial changes (e.g., vectors) for points of an object model. For example, predicting 102 the deformed model for an initial iteration may predict sintered object model geometry in accordance with X_{f}=X₀+U. In some examples, predicting 102 the deformed model for a subsequent iteration (e.g., an iteration after the initial iteration) may be performed in accordance with X_{f}=Xᵢ+U, where Xᵢ may denote a previous compensated model and/or a previous proposed model. For example, the apparatus may predict the displacement field U, where the deformed (e.g., sintered) object may be based on Xᵢ as X_{f}=Xᵢ+U. The displacement field U may vary from iteration to iteration.

In some examples, the apparatus may determine 104, in the iteration, a disparity between the object model and the deformed model. A disparity is a difference (e.g., subtraction, spatial distance, etc.) between models. For example, a disparity may include a value, values, vector, and/or vectors indicating a difference or differences between the object model and the deformed model. For the initial iteration, the disparity may be the displacement field U. For a subsequent iteration, determining 104 the disparity may include determining a difference (e.g., subtraction) between the object model (e.g., target object model, original object model, and/or X₀) and the deformed model (e.g., X_{f}). For instance, the disparity may be determined 104 in accordance with ΔX=X_{f}−X₀, where ΔX is the disparity.

In some examples, the apparatus may determine whether the deformed model is within a tolerance. A tolerance is a condition and/or threshold. For example, a tolerance may indicate an amount of acceptable deviation from the target object model. Examples of the tolerance (e.g., deviation relative to a target model) may include 0.01%, ±0.1%, ±0.5%, 1%, 3%, 5%, 7%, 10%, etc., and/or a range or ranges in unit(s) of measure (e.g., 1 millimeter (mm), ±0.3 centimeters (cm), ±0.25 inches, etc.). In some examples, the apparatus may compare the disparity or another metric (e.g., mean square error, sum of distances between the deformed model and the target object model, etc.) to the tolerance. In a case that the tolerance is not satisfied (e.g., the disparity is greater than the tolerance), the apparatus may proceed to a next iteration. For example, the prediction (e.g., sintered object geometry and/or other associated voxel-level data) may be utilized in the next iteration to generate a next proposed object model (of a precursor object, for instance) and so on. In a case that the tolerance is satisfied (e.g., the disparity is within or equal to the tolerance), the apparatus may discontinue iteration (e.g., end the loop).

In some examples, the apparatus may determine 106 in the next iteration, a compensated model based on the disparity and a relaxation factor. A relaxation factor is a value. For instance, the relaxation factor may be a value between 0 and 1 (e.g., 0.25, 0.4, 0.55, 0.73, 0.85, etc.). The relaxation factor may be denoted ω. In some examples, determining 106 the compensated model may include determining a product of the disparity and the relaxation factor, and determining a difference between a previous model and the product to produce the compensated model. The previous model may be the target object model (e.g., original object model), a previous compensated model (e.g., a compensated model from a previous iteration), or a previous proposed model (e.g., a proposed model from a previous iteration). In some examples for an initial iteration, the compensated model may be determined 106 in accordance with Xᵣ=X₀−ωU, where Xᵣ may denote a compensated model and/or a proposed model. For instance, Xᵣ may indicate a mesh for further deformation prediction and/or disparity determination. In some examples for a subsequent iteration (after the initial iteration, for instance), the compensated model may be determined 106 in accordance with Xᵣ=Xᵢ−ωΔX. In some examples, the compensated model and/or proposed model may attempt to compensate for (e.g., correct) a difference between the target object model and the most recent deformed model. In some examples, U≠αΔX for any α. In some examples, i may denote an index and/or iteration number. For example, an (i+1)th proposal may be generated based on an i-th proposal. In some examples, r may denote a current, most recent, and/or last iteration.

Some examples of the techniques described herein may help to address non-linear sintering processes. The value of the relaxation factor (e.g., w) may be tuned. For instance, if the relaxation factor is too large, convergence may be adversely impacted due to instability in the procedure (e.g., the deformed model and/or sintered object may fail to achieve a ΔX within tolerance). Smaller relaxation factors may result in additional processing, iterations, and/or time to produce a proposed model that leads to a deformed model and/or sintered model within tolerance. For a given sintering process (e.g., sintering oven and master sintering curve) and a given type of precursor object (e.g., MetJet, MIM, etc.), numerical experiments may be carried out to map object geometrical characteristics and a tuned w value.

In some examples, the relaxation factor may vary over iterations. For example, w may not necessarily be the same from iteration to iteration and/or may change from iteration to iteration. In some examples, the method 100 may include determining the relaxation factor based on a gradient of the displacement field (e.g., U) over the disparity (e.g., ΔX). For instance, the relaxation factor may be determined based on the stiffness of the gradient of U over ΔX. If a relatively large change of consecutive proposed models results in small changes of U, then a larger w may be determined and/or utilized to accelerate convergence.

In some examples, the relaxation factor (e.g., ω) may vary over space (e.g., a spatial dimension or dimensions, voxels, etc.). For example, the relaxation factor may not be homogenous throughout an entire object and/or may vary from voxel to voxel. In some examples, the method 100 may include determining the relaxation factor based on voxel porosity. For instance, a voxel porosity may be associated with each voxel. For instance, porosity may be expressed as a set of porosity values (e.g., numbers) corresponding to locations (e.g., voxels) over the object and/or voxel space. For example, each of the porosity values (e.g., numbers) may be a scalar associated with a voxel that describes a percentage of the void of the voxel. Porosity values may vary from voxel to voxel. The apparatus may determine the relaxation factor for a voxel based on the voxel porosity associated with the voxel. For example, ω may be a function of the porosity of each voxel. In some examples, a porosity (which may be denoted ρ, for instance) for a voxel may be defined as a fractional volume of a voxel that is unoccupied or that is occupied by a void (e.g., space, air, without material, etc.). In some examples, the relaxation factor (e.g., ω) may be expressed as ω=c₁/(c₂−ρ), where c₁ and c₂ are non-zero constants. Determining the relaxation factor may be helpful in some cases where the porosity varies significantly from voxel to voxel and/or where the porosity variation may contribute significantly sintered object deformation. Having w tuned for voxel-level porosity may accelerate convergence of a proposed object for precursor object geometry.

In some examples, a compensation may exceed a boundary when applied to voxels at object boundaries (e.g., object areas touching the floor of the sintering oven). A compensation is a movement of object geometry. For instance, a compensation may be an expansion and/or enlargement of object geometry (in attempting to produce a compensated model and/or proposed model, for example). In some examples, a compensation may be represented as a compensation vector or compensation vectors. In some examples, the compensation may be constrained. In some examples, determining 106 the compensated model may include detecting a compensation that exceeds a constraint (e.g., boundary, border, limit, etc.). For instance, the apparatus may determine whether a compensation (e.g., expansion, movement, etc.) exceeds a constraint. A constraint may be a geometrical limit and/or threshold. For instance, if a compensated point(s) and/or portion(s) of an object model exceed a spatial constraint (e.g., go beyond a spatial limit, range, plane, boundary, etc.), the apparatus may detect that a compensation exceeds a constraint.

In some examples, the method 100 may include adjusting the compensation. For example, determining 106 the compensated model may include projecting the compensation onto the constraint. For instance, the apparatus may project the compensation onto a plane, surface, and/or line that represents the constraint. In some examples, the projection may be performed in a direction perpendicular to the plane, surface, and/or line. In some examples, operation(s), function(s), and/or element(s) of the method 100 may be omitted and/or combined.

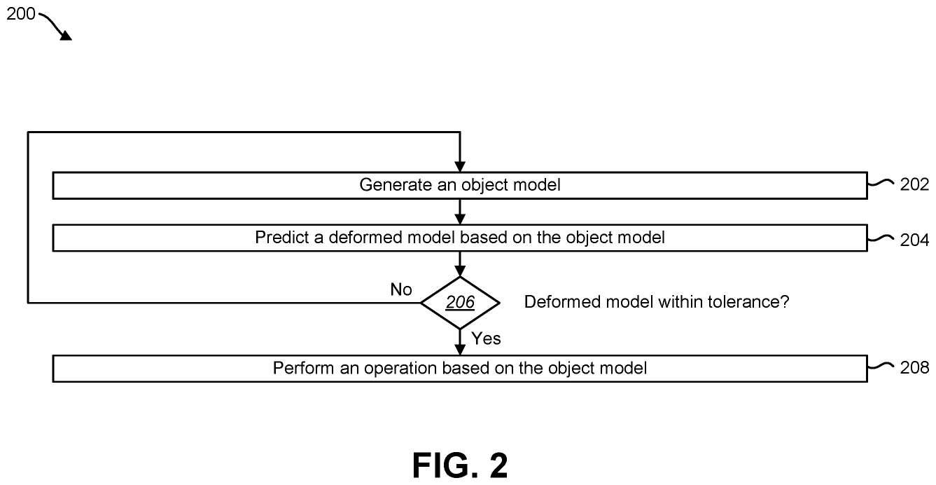

FIG. 2 is a flow diagram illustrating another example of a method 200 for iterative model compensation. The method 200 and/or an element or elements of the method 200 may be performed by an apparatus (e.g., electronic device). For example, the method 200 may be performed by the apparatus 302 described in connection with FIG. 3.

The apparatus may generate 202 an object model. Examples of the object model may include a target object model, an original object model, a compensated model, and/or a proposed model. In some examples, generating 202 the object model may be performed as described in relation to FIG. 1. For example, the apparatus may receive the object model from another device. For instance, the apparatus may receive the object model from another device over a wired or wireless link (e.g., network, Internet, etc.) and/or from removable storage (e.g., flash drive, external drive, etc.). In some examples, the apparatus may receive input to form the object model and/or may produce the object model as a compensated model and/or proposed model based on a deformed model from a previous iteration. For instance, the apparatus may determine Xᵣ=X₀−ωU or Xᵣ=Xᵢ−ωΔX. In some examples, the apparatus may propose a geometry to be printed as a precursor object in an attempt to produce a sintered object to meet a target geometry. In some approaches, the apparatus may utilize the target geometry as an initial object model. In some approaches, the apparatus may utilize prediction to validate and/or provide detailed voxel level analyses to tune the proposed geometry.

The apparatus may predict 204 a deformed model based on the object model. In some examples, predicting 204 the deformed model may be performed as described in relation to FIG. 1. For example, the apparatus may simulate and/or infer a deformation of the object model in a sintering process. Predicting 204 the deformed model may produce a displacement field indicating the displacement of a point or points of the object model.

The apparatus may determine 206 whether the deformed model is within a tolerance. In some examples, determining 206 whether the deformed model is within a tolerance may be performed as described in relation to FIG. 1. For example, the apparatus may compare U or ΔX to the tolerance. In a case that the deformed model is not within the tolerance (e.g., U or ΔX does not satisfy the tolerance), operation may return generating 202 an object model. For instance, due to a deformation from a simulated sintering process, an original object model may not meet the tolerance. For example, U may be relatively significant, and the deformed model X_{f} may fall outside of a tolerance centered on the target object model (e.g., X₀), which may trigger an additional iteration. Accordingly, an additional iteration may be performed to produce a compensated model. For instance, the apparatus may generate 202 a new compensated model in accordance with Xᵣ=Xᵢ−ωΔX, where Xᵢ is the compensated model from the previous iteration. In some examples, iterative proposals may converge to the target object geometry that may result in sintered object geometry with increased accuracy (e.g., ΔX that is within tolerance and/or near-zero).

In a case that the deformed model is within tolerance, the apparatus may perform 208 an operation based on the object model (e.g., the compensated model, the proposed model, etc.). For example, the apparatus may present the object model (e.g., compensated model, proposed model, etc.) on a display, may store the object model (e.g., compensated model, proposed model, etc.) in memory, and/or may send the object model (e.g., compensated model, proposed model, etc.) to another device or devices. In some examples, the apparatus may print a precursor object based on the object model (e.g., compensated model, proposed model, etc.). For example, the apparatus may print the precursor object based on two-dimensional (2D) maps or slices of the object model (e.g., compensated model, proposed model, etc.) indicating placement of binder agent (e.g., glue). In some examples, agent maps may be examples of per-layer machine instructions. For instance, an agent map or agent maps may be generated for each slice of the object model. For example, an agent map may indicate an area or areas for printing agent (e.g., binding agent, glue, latex, etc.) for a layer. The agent map or maps may be represented in a variety of formats in some examples. For instance, an agent map may be represented as an image file, a 2D grid, or a 2D array of values that indicate locations (e.g., pixels or voxels) for printing the agent. In some examples, performing 208 the operation may be performed after a final compensated object model is determined (e.g., converged). In some examples, operation(s), function(s), and/or element(s) of the method 200 may be omitted and/or combined.

FIG. 3 is a block diagram of an example of an apparatus 302 that may be used in iterative model compensation. The apparatus 302 may be a computing device, such as a personal computer, a server computer, a printer, a 3D printer, a smartphone, a tablet computer, etc. The apparatus 302 may include and/or may be coupled to a processor 304 and/or a memory 306. The memory 306 may be in electronic communication with the processor 304. In some examples, the apparatus 302 may be in communication with (e.g., coupled to, have a communication link with) an additive manufacturing device (e.g., a 3D printing device). In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., prediction instructions 312 and/or geometrical change instructions 314) stored in the memory 306. In some examples, the processor 304 may include an electronic circuit or circuits that include electronic components for performing a functionality or functionalities of the instructions (e.g., prediction instructions 312 and/or geometrical change instructions 314). In some examples, the processor 304 may perform one, some, or all of the functions, operations, elements, methods, etc., described in connection with one, some, or all of FIGS. 1-6.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and store the information pertaining to the objects for which compensation may be determined. The input/output interface may include hardware and/or machine-readable instructions to enable the processor 304 to communicate with the external device or devices. The input/output interface may enable a wired or wireless connection to the external device or devices. In some examples, the input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions into the apparatus 302. In some examples, the apparatus 302 may receive 3D model data 308 from an external device or devices (e.g., computer, removable storage, network device, etc.).

In some examples, the memory 306 may store 3D model data 308. The 3D model data 308 may be generated by the apparatus 302 and/or received from another device. Some examples of 3D model data 308 include a 3D manufacturing format (3MF) file or files, a 3D computer-aided design (CAD) image, object shape data, mesh data, geometry data, etc. The 3D model data 308 may indicate the shape an object or objects. In some examples, the 3D model data 308 may indicate a packing of a build volume, or the apparatus 302 may arrange 3D object models represented by the 3D model data 308 into a packing of a build volume. In some examples, the 3D model data 308 may be utilized to obtain slices of a 3D model or models. For example, the apparatus 302 may slice the model or models to produce slices, which may be stored in the memory 306. In some examples, the 3D model data 308 may be utilized to obtain an agent map or agent maps of a 3D model or models. For example, the apparatus 302 may utilize the slices to determine agent maps (e.g., voxels or pixels where agent(s) are to be applied), which may be stored in the memory 306.

The memory 306 may store prediction instructions 312. In some examples, the processor 304 may execute the prediction instructions 312 to predict a displacement field based on an object model. In some examples, the displacement field may be predicted based on an object model in a voxel space. In some examples, this may be accomplished as described in relation to FIG. 1 and/or FIG. 2. For instance, the processor 304 may simulate and/or infer the displacement field based on the object model (e.g., target object model, previous proposed model, etc.).

The memory 306 may store geometrical change instructions 314. In some examples, the processor 304 may execute the geometrical change instructions 314 to determine a geometrical change from a previous proposed model as a function of the displacement field and a relaxation factor that varies over a spatial dimension. The geometrical change may be denoted (Xᵣ−Xᵢ) in some approaches. In some examples, the geometrical change may be computed as a linear function of the displacement field (e.g., U) regulated by the relaxation factor (e.g., ω) as described herein. In some examples, the function may have a polynomial degree of 1. A piecewise linear approximation from iteration to iteration can capture the non-linearity of the convergence dynamics in some examples. In some examples, another relationship may be utilized.

In some examples, the function of the displacement field may be based on a polynomial of the displacement field with a polynomial degree that is greater than 1. For instance, the geometrical change (e.g., (Xᵣ−Xᵢ)) may be a higher order polynomial of U. For example, Xᵣ=Xᵢ−ω*(c₀*(U−c₁)₂+c₂*(U−c₃)+c₄), where c₀, c₁, c₂, c₃, and c₄ are numerical values (e.g., constants).

In some examples, the geometrical change may be a function of a voxel-associated property. For instance, the geometrical change (e.g., (Xᵣ−Xᵢ)) may be a function of U and additional voxel-level properties (e.g., porosity). In some examples, Xᵣ=Xᵢ−ω*ΔX−c₀/(c₁−ρ), where ρ denotes porosity at a voxel level and c₀ and c₁ are constants.

In some examples, a sintering process may be modeled as a transient, dynamic, and/or non-linear process. In some examples, predicting the displacement field may produce a sequence of displacement fields (e.g., U₁, U₂, . . . , Uₙ) that correspond to deformations at discrete time values (e.g., t₁, t₂, . . . , tₙ). Some examples of the techniques described herein may utilize the final displacement field. For instance, the geometrical change (e.g., (Xᵣ−Xᵢ)) may be a function of the displacement Uₙ regulated by w. In some examples, the geometrical change may be a function of a series of displacement fields. For instance, it may be helpful to have the geometrical change (e.g., (Xᵣ−Xᵢ)) as a function of the vector (U₁, U₂, . . . , Uₙ). For instance, using the vector (U₁, U₂, . . . , Uₙ) may be helpful in approaches where multiple sintering ovens or more complex sintering thermal profiles are used (e.g., a debinding process followed by sintering). Explicitly tracking the deformation via the vector (U₁, U₂, . . . , Uₙ) may accelerate convergence. In some examples, the geometrical change may be based on a series of displacement fields in accordance with Xᵣ=Xᵢ−Σᵢ₌₁^{N}ωᵢ*Uᵢ.

The memory 306 may store operation instructions 318. In some examples, the processor 304 may execute the operation instructions 318 to perform an operation based on the prediction and/or compensation. For example, the apparatus 302 may present the object model (e.g., compensated model, proposed model, etc.) on a display, may store the object model (e.g., compensated model, proposed model, etc.) in memory 306 (as 3D model data 308, for instance), and/or may send the object model (e.g., compensated model, proposed model, etc.) to another device or devices. In some examples, the apparatus 302 may print a precursor object based on the object model (e.g., compensated model, proposed model, etc.). For example, the apparatus 302 may print the precursor object based on two-dimensional (2D) maps or slices of the object model (e.g., compensated model, proposed model, etc.) indicating placement of binder agent (e.g., glue).

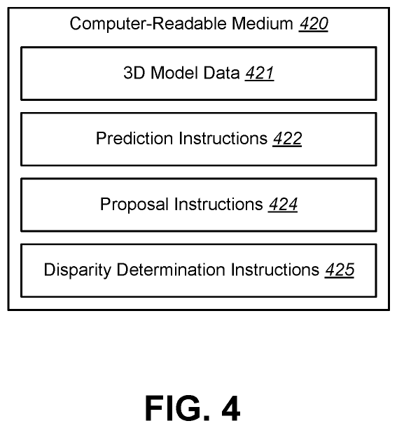

FIG. 4 is a block diagram illustrating an example of a computer-readable medium 420 for iterative model compensation. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and/or the like. In some implementations, the memory 306 described in connection with FIG. 3 may be an example of the computer-readable medium 420 described in connection with FIG. 4.

The computer-readable medium 420 may include code (e.g., data and/or instructions, executable code, etc.). For example, the computer-readable medium 420 may include 3D model data 421, prediction instructions 422, proposal instructions 424, and/or disparity determination instructions 425.

In some examples, the computer-readable medium 420 may store 3D model data 421. Some examples of 3D model data 421 include a 3D CAD file, a 3D mesh, etc. The 3D model data 421 may indicate the shape of a 3D object or 3D objects (e.g., object model(s)).

In some examples, the prediction instructions 422 are code to cause a processor to predict a first displacement field based on a target object model. In some examples, this may be accomplished as described in connection with FIG. 1, FIG. 2, and/or FIG. 3. For instance, the prediction instructions 422 may be executed to predict a first U based on X₀.

In some examples, the proposal instructions 424 are code to cause a processor to determine a first proposed model based on the first displacement field and a relaxation factor. In some examples, this may be accomplished as described in connection with FIG. 1, FIG. 2, and/or FIG. 3. For instance, the proposal instructions 424 may be executed to determine Xᵢ based on the first U and ω (e.g., Xᵢ=X₀−ωU).

In some examples, the prediction instructions 422 are code to cause a processor to predict a second displacement field based on the first proposed model to produce a deformed model. In some examples, this may be accomplished as described in connection with FIG. 2 and/or FIG. 3. For instance, the prediction instructions 422 may be executed to predict a second U based on Xᵢ.

In some examples, the disparity determination instructions 425 are code to cause a processor to determine a disparity based on the deformed model and the target object model. In some examples, this may be accomplished as described in connection with FIG. 1, FIG. 2, and/or FIG. 3. For instance, the disparity determination instructions 425 may be executed to determine the disparity ΔX based on the deformed model X_{f} and the target object model X₀ (e.g., ΔX=X_{f}−X₀).

In some examples, the proposal instructions 424 are code to cause a processor to determine a second proposed model based on the first proposed model, the relaxation factor, and the disparity. In some examples, this may be accomplished as described in connection with FIG. 1, FIG. 2, and/or FIG. 3. For instance, the proposal instructions 424 may be executed to determine Xᵣ based on ω and ΔX (e.g., Xᵣ=Xᵢ−ωΔX). In some examples, the computer-readable medium 420 may include code to cause a processor to determine that the disparity does not meet a tolerance, where determining the second proposed model may be performed in response to determining that the disparity does not meet the tolerance.

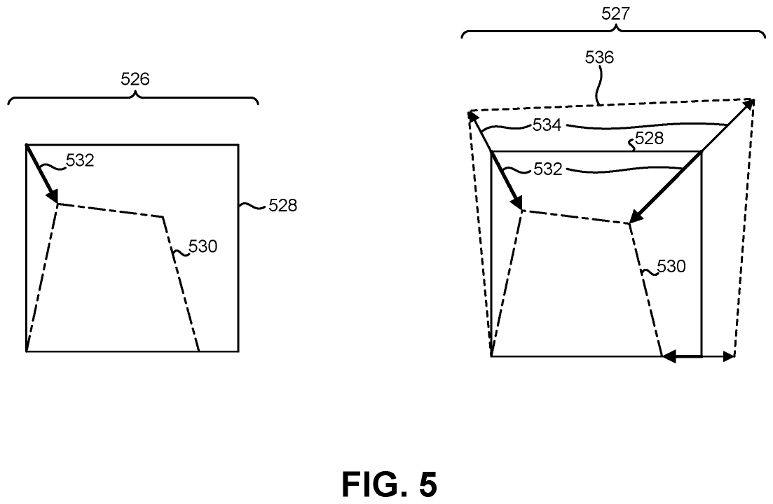

FIG. 5 is a diagram illustrating an example of deformed model prediction 526 and an example of compensated model determination 527 in accordance with some examples of the techniques described herein. FIG. 5 illustrates a target object model 528, which may represent a target shape and/or size for an object after deformation. In the example of deformed model prediction 526, a deformed model 530 (e.g., X_{f}) is predicted by determining and/or predicting a displacement field. In FIG. 5, the displacement field (e.g., U) is represented by displacement vectors 532, which may indicate spatial differences between points of the target object model 528 and corresponding points of the predicted deformed model 530. As illustrated in FIG. 5, the deformed model 530 may initially have significant differences in shape and/or size from the target object model 528.

In the example of compensated model determination 527, a compensation may be determined. The compensation may be represented by compensation vectors 534, which may indicate calculated compensation in accordance with some of the techniques described herein (e.g., Xᵣ=X₀−ωU). A compensated model 536 (e.g., Xᵣ) may be determined. As illustrated in the example of FIG. 5, the compensated model 536 is an expansion of an object model (e.g., an expansion of the target object model 528 in this example). The relaxation factor may scale (e.g., scale down) a vector or vectors in an opposite direction or directions from the displacement field (e.g., displacement vectors 532) to produce the compensated model 536.

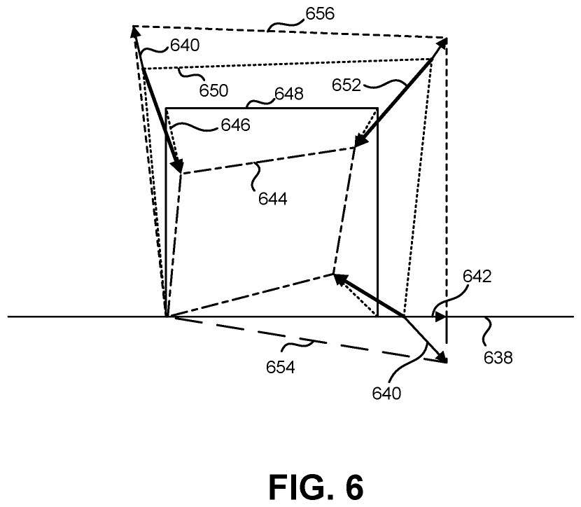

FIG. 6 is a diagram illustrating an example of iterative model compensation in accordance with some examples of the techniques described herein. FIG. 6 illustrates a target object model 648 (e.g., X₀), which may represent a target shape and/or target size for an object after deformation. In this example, a deformed model 644 (e.g., X_{f}) is predicted by determining and/or predicting a displacement field (e.g., U). In FIG. 6, the displacement field is represented by displacement vectors 652, which may indicate spatial differences between points of the deformed model 644 and corresponding points of a first compensated model 650 (e.g., Xᵢ). As illustrated in FIG. 6, the deformed model 644 may have significant differences in shape and/or size from the target object model 648.

In the example of FIG. 6, a compensation may be determined at a first iteration to produce the first compensated model 650. Because the deformed object model 644 is not within a tolerance relative to the target object model 648, a second iteration may be performed. For example, after the first iteration, a disparity (e.g., ΔX) may be determined. In FIG. 6, the disparity is represented by disparity vectors 646. Compensation may be determined in a second iteration based on the first compensated model 650 (e.g., Xᵢ), the disparity and the relaxation factor (e.g., Xᵣ=Xᵢ−ωΔX). The compensation may be represented by compensation vectors 640, which may indicate calculated compensation in accordance with some of the techniques described herein.

In this example, the compensation exceeds a constraint 638. For example, one of the compensation vectors 640 extends beyond the constraint 638. In this example, the compensation (e.g., a portion of the compensation, the compensation vector 640 beyond the constraint 638) may be projected onto the constraint 638. For instance, a compensation vector 640 beyond the constraint may be projected onto the constraint 638 to produce a compensated vector 642. The compensation may be partially modified to reduce and/or avoid a portion of the compensation 654 and/or second compensated model 656 extending beyond the constraint 638. A second compensated model 656 (e.g., Xᵣ) may result from the iterative prediction and compensation (with the adjustment for the compensation beyond the constraint 638). As illustrated in the example of FIG. 6, the second compensated model 656 is an expansion of the first compensated model 650. The compensation vectors 640 may be based on the disparity vectors 646 (e.g., scaled down vectors in an opposite direction from the disparity vectors 646 originating at points of the first compensated model 650).

While various examples of techniques are described herein, the techniques are not limited to the examples. Variations of the examples described herein may be implemented within the scope of the disclosure. For example, operations, functions, aspects, or elements of the examples described herein may be omitted or combined.

1. A method, comprising:
predicting, in an iteration, a deformed model based on an object model;
determining, in the iteration, a disparity between the object model and the deformed model; and
determining, in a next iteration, a compensated model based on the disparity and a relaxation factor.

2. The method of claim 1, wherein determining the disparity comprises determining a difference between the object model and the deformed model.

3. The method of claim 1, wherein determining the compensated model comprises:
determining a product of the disparity and the relaxation factor; and
determining a difference between a previous model and the product to produce the compensated model.

4. The method of claim 1, wherein the relaxation factor varies over iterations.

5. The method of claim 4, further comprising determining the relaxation factor based on a gradient of a displacement field over the disparity.

6. The method of claim 1, wherein the relaxation factor varies over voxels.

7. The method of claim 6, further comprising determining the relaxation factor based on voxel porosity.

8. The method of claim 1, wherein determining the compensated model comprises detecting a compensation that exceeds a constraint.

9. The method of claim 8, wherein determining the compensated model comprises projecting the compensation onto the constraint.

10. An apparatus, comprising:
a memory;
a processor in electronic communication with the memory, wherein the processor is to:
predict a displacement field based on an object model; and
determine a geometrical change from a previous proposed model as a function of the displacement field and a relaxation factor that varies over a spatial dimension.

11. The apparatus of claim 10, wherein the function of the displacement field is based on a polynomial of the displacement field with a polynomial degree greater than 1.

12. The apparatus of claim 10, wherein the geometrical change is a function of a voxel-associated property.

13. The apparatus of claim 10, wherein the geometrical change is a function of a series of displacement fields.

14. A non-transitory tangible computer-readable medium storing executable code, comprising:
code to cause a processor to predict a first displacement field based on a target object model;
code to cause the processor to determine a first proposed model based on the first displacement field and a relaxation factor;
code to cause the processor to predict a second displacement field based on the first proposed model to produce a deformed model;
code to cause the processor to determine a disparity based on the deformed model and the target object model; and
code to cause the processor to determine a second proposed model based on the first proposed model, the relaxation factor, and the disparity.

15. The computer-readable medium of claim 14, further comprising code to cause the processor to determine that the disparity does not meet a tolerance, and wherein determining the second proposed model is performed in response to determining that the disparity does not meet the tolerance.
